(19) United States
(12) Patent Application Publication
(10) Pub. No.: US 2008/0317084 A1
(43) Pub. Date: Dec. 25, 2008

(54) Laser Interferometer Mirror Assembly

(76) Inventor: Tao Zhang, Cambridge (GB)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/628,117

(22) PCT Filed: May 12, 2005
(86) PCT No.: PCT/GB05/50065

§ 371 Date: Feb. 4, 2008

(30) Foreign Application Priority Data
Jun. 3, 2004 (GB) 0412429.3

(51) Int. Cl. H01S 3/08; G01B 9/02

(52) U.S. Cl. 372/98; 356/450

(57) ABSTRACT

A laser interferometer mirror assembly (1) comprises a glass base (2) and first and second orthogonal glass mirror blocks (3, 4) each mirror block being supported on an upper surface (5) of the glass base using a pair of feet (6, 7, 8, 9).

### FIELD OF THE INVENTION

The present invention relates to a laser interferometer mirror assembly particularly, but not exclusively for use in an electron beam lithography system.

### BACKGROUND ART

In an electron beam lithography system, a laser interferometer mirror assembly is usually placed between an x-y positioning stage and a chuck which holds a workpiece. The mirror assembly includes an orthogonal pair of plane mirrors upstanding from a base portion. Thus, when the chuck is placed on the base portion, the workpiece supported by the chuck sits at substantially the same height as the mirrors.

A conventional mirror assembly is machined from a single block of glass typically having a thickness of about 30-60 mm. Leaving two outwardly-facing orthogonal sides of the block uncut, the block is thinned to form an open-sided recess about 15 to 20 mm deep with a ledge running along two sides of the recess, along the two uncut sides of the block. Upper portions of the uncut sides are polished to form mirrors.

The block of glass must be thick enough to permit it to be machined. However, this results in a heavy mirror assembly. If a thinner block is used, the block is likely to break during machining.

One solution is to provide a mirror assembly having a flat glass base and two mirror blocks glued onto the base. However, variations in surface height of the base deform the mirror blocks. Thus, unless the base is polished to an exceptionally high degree of flatness, i.e. to less than 1 μm, then the mirror assembly does not provide sufficiently flat mirrors for laser interferometry.

The present invention seeks to provide an improved mirror assembly.

### SUMMARY OF THE INVENTION

According to the present invention there is provided a mirror assembly comprising a glass base having an upper surface and first and second glass mirror blocks, each of the glass mirror blocks being supported on the upper surface of the glass base using a set of two or three glass supports, each support being glued to the glass block, each mirror block being glued to a respective set of supports and the first and second glass mirror blocks being arranged on the glass mirror block to provide first and second orthogonal mirrors.

The mirror assembly has an advantage in that it can be easily manufactured since the base and mirrors do not have to be machined as an integral unit from the same block. Furthermore, gluing each support to the glass block and gluing each mirror block to a respective set of supports can help to provide a rigid structure.

The base, mirror blocks and supports may be formed of the same glass material, such as Zerodur® glass. The mirror blocks may be arranged along orthogonal sides of the base. The mirror blocks may have outwardly facing sides which are laterally level with outwardly facing sides of the base.

The base may have a thickness between 5 and 10 mm or an aspect ratio of between 0.025:1 and 0.05:1

The supports may be in the form of spacers and may have a thickness of less than 1 mm and may have a width of between 1 and 10 mm.

The upper support may be substantially flat.

### BRIEF DESCRIPTION OF THE DRAWINGS

Embodiments of the present invention will now be described, by way of example, with reference to the accompanying drawing in which:

FIG. 1 is a perspective view of a laser interferometer mirror assembly in accordance with the present invention;

FIG. 2 is a side view of the mirror assembly shown in FIG. 1;

FIG. 3 is a plan view of the mirror assembly shown in FIG. 1;

FIG. 4 is a plan view of a part of another laser interferometer mirror assembly in accordance with the present invention; and

FIG. 5 is a side view of an x-y positioning stage, a laser interferometer mirror assembly in accordance with the present invention, a chuck and a chuck support.

### DETAILED DESCRIPTION OF THE INVENTION

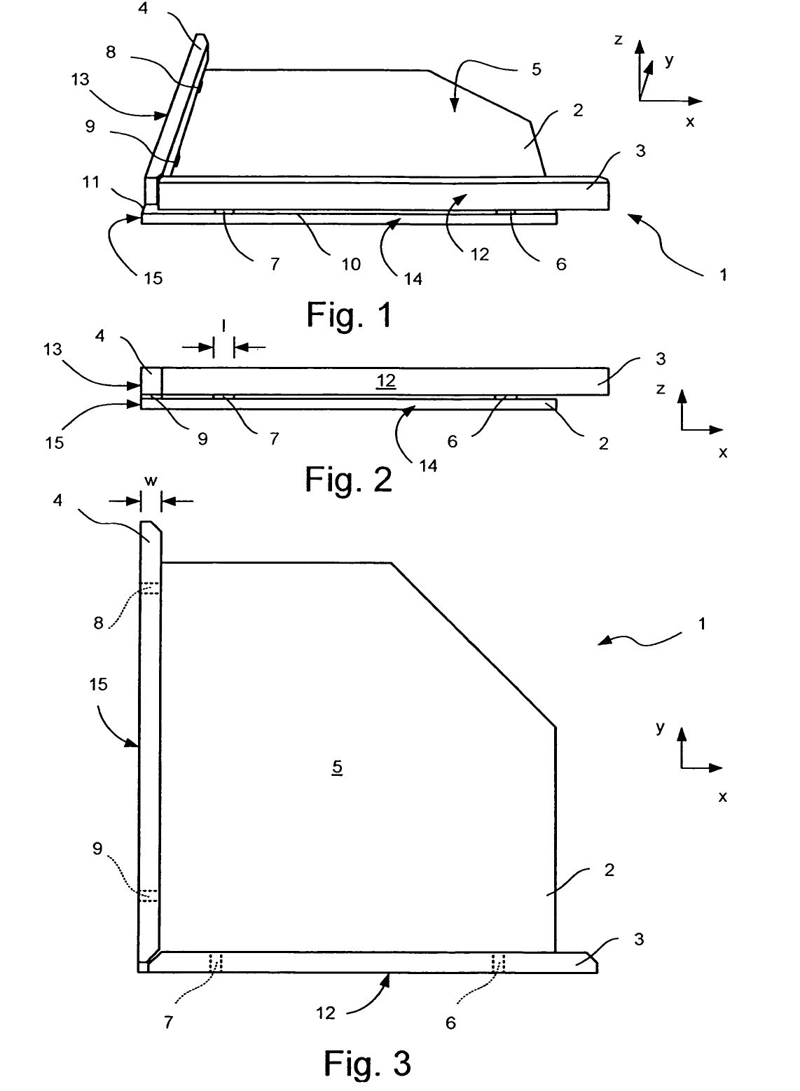

Referring to FIGS. 1, 2 and 3, an embodiment of a laser interferometer mirror assembly 1 according to the present invention comprises a glass base 2 and first and second glass mirror blocks 3, 4 mounted to an upper surface 5 of the glass base 2 by respective pairs of glass supports or feet 6, 7, 8, 9. The base 2, mirror blocks 3, 4 and supports 6, 7, 8, 9 are formed from Zerodur® glass. However, other glasses which have a low coefficient of thermal expansion may be used.

The glass base 2 is generally rectangular, with a chamfered edge, in plan view and is flat to within 10 μm across an upper surface 5. The areal size the glass base 2 depends on the size of workpiece carried by a chuck 18 (FIG. 7) carried by the x-y positioning stage 17 (FIG. 5). In this case, the glass base 2 has side lengths of about 200 mm. The thickness of the glass base 2 is 7 mm. The thickness of the glass base 2 may between 5 and 10 mm. Thus, aspect ratios (e.g. height to width) of between 0.025:1 and 0.05:1 may be achieved.

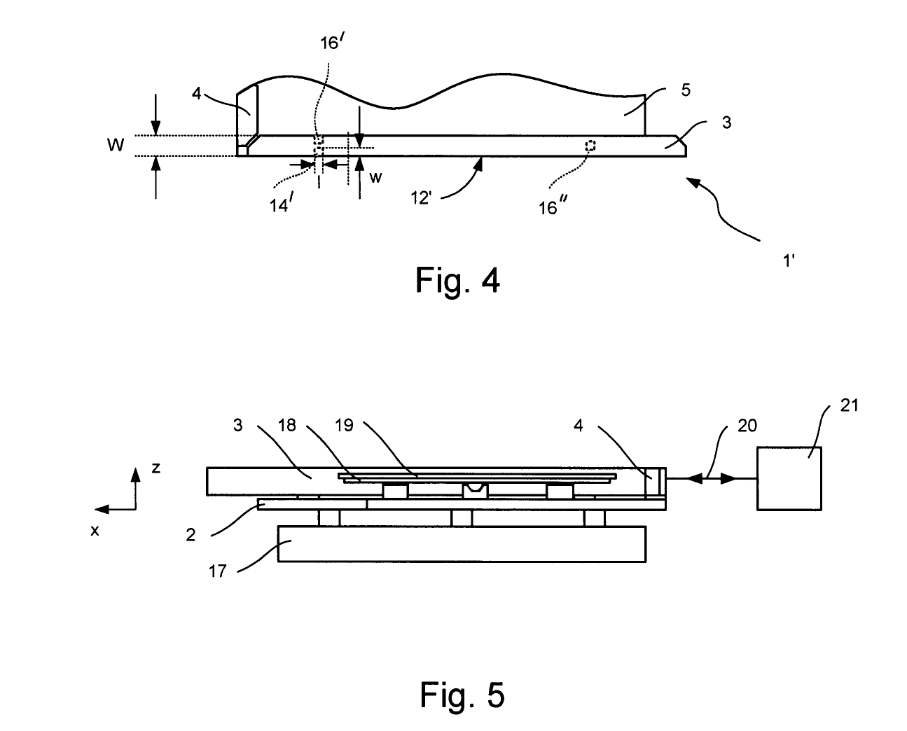

The mirror blocks 3, 4 are arranged on the upper surface 5 of the glass base 2 along two orthogonal sides 10, 11. In this example, the mirror blocks 3, 4 are longitudinally perpendicular. The blocks 3, 4 have outwardly-facing sides 12, 13 which are laterally level with outwardly-facing sides 14, 15 of the glass base 2. The mirror blocks 3, 4 overhang from the base 2. The mirror blocks 3, 4 have a width of 5 mm and a thickness of 10 mm. The outwardly-facing sides 12, 13 are polished to provide respective λ/20 mirrors for reflecting a laser beam 17 (FIG. 4).

The supports 6, 7, 8, 9 are in the form of flat spacers and have a width, w, (across the width of the mirror block) of 12 mm, a length, l, (along the length of the mirror block) of 5 mm and a height, b, (thickness) of 0.5 mm. The supports 6, 7, 8, 9 may have a width between 1 and 15 mm. The supports may have a length between 1 and 15 mm. The supports 6, 7, 8, 9 need not have the same width as the mirror blocks 3, 4. Square supports (wherein w=l) may be used. Shorter and narrower spacers can be used if they provide enough bonding force, which can be determined by routine experiment.

A pair of supports 6, 7, 8, 9 are provided for each mirror block 3, 4. Each pair of supports 6, 7, 8, 9 6, 7 overlie the base 2 and underlie a respective mirror block 3, 4. For each mirror block 3, 4, one support 6, 8 is provided approximately one-quarter of the way along the block 3, 4 and another support 7, 9 is provided approximately three-quarters of the way along the block 3, 4. However, a pair of supports 6, 7, 8, 9 may be provided at other equally spaced distances from each end of the mirror block 3. For example, a support 6, 7, 8, 9 may be provided at each end of each mirror block 3, 4. The supports 6, 7, 8, 9 may be provided at non-equally spaced distances.

The supports 6, 7, 8, 9 are attached to the base 2 and to the mirror blocks 3, 4 using glue. Preferably, the glue has a low viscosity when wet for helping to apply a thin, uniform layer of glue.

Supporting a mirror block 3, 4 using two narrow, flat feet 6, 7, 8, 9 helps to minimise deformation of the mirror block 3, 4 and to keep the face 12, 13 of the mirror blocks 3, 4 flat. The footprint of each foot 6, 7, 8, 9, i.e. the area covered by the foot, is small, thus exposing the mirror blocks 3, 4 to less surface variation than, for example gluing the mirror blocks 3, 4 directly to the base 2.

Because the mirror blocks 12, 13 can be attached to the base 2, the mirror assembly 1 does not need to be machined from a single block. Thus, a thinner base 2 can be used. This results in a lighter mirror assembly which reduces the load on the x-y positioning stage 17 (FIG. 5). Therefore, an assembly including the stage can react more quickly, with a shorter settling time, which helps increase the throughput of an electron beam lithography system.

Referring to FIG. 4, a part of another embodiment of a laser interferometer mirror assembly 1′ according to the present invention is shown. The mirror assembly 1′ is substantially similar to the mirror assembly 1 described earlier. However, instead of two supports 6, 7, three supports 14, 15, 16, arranged in a triangle, are provided for mirror block 3. The supports 14, 15, 16 are substantially square in plan view. The width, w, and the length, 1, of the supports 14, 15, 16 are less than the width, W, of the mirror block 3. Three supports (not shown) are also provided for mirror block 4. However, one mirror block 4 may have two supports and the other mirror block 3 may have three supports.

Supporting a mirror block 3, 4 using three small supports 14, 15, 16 helps to minimise deformation of the mirror block 3, 4.

Referring to FIG. 5, the mirror assembly 1 is mounted on an x-y positioning stage 17 driven by stepper motors (not shown). A chuck 18 for carrying a workpiece or specimen 19, such as a semiconductor wafer, is mounted on the mirror assembly 1. The position of the workpiece or specimen 19 can be determined by directing respective laser beams 20 from positioning units 21 (only one positioning unit is shown for clarity).

It will be appreciated that many modifications may be made to the embodiments hereinbefore described. For example, the mirror assembly may be used in other microlithography systems, such as ion beam systems, microscopy systems, such as scanning electron microscope, and other systems using interferometry. The supports may protrude from under the mirror blocks. In other words, a part of an upper surface of a support may be in contact with the mirror block.

1. A laser interferometer mirror assembly comprising:
a glass base having an upper surface; and
first and second glass mirror blocks;
each of said glass mirror blocks being supported on said upper surface of said glass base using a set of two or three glass supports, each support being glued to the glass base, each mirror block being glued to a respective set of supports and said first and second glass mirror blocks being arranged on said glass base to provide first and second orthogonal mirrors.

2. A mirror assembly according to claim 1, wherein said base, mirror blocks and supports are formed of the same glass material.

3. A mirror assembly according to claim 2, wherein the glass material is Zerodur® glass

4. A mirror assembly according to claim 1, wherein said mirror blocks are arranged along orthogonal sides of said base.

5. A mirror assembly according to claim 1, wherein said mirror blocks have outwardly facing sides which are laterally level with outwardly facing sides of the base.

6. A mirror assembly according to claim 1, wherein said base has thickness between 5 and 10 mm.

7. A mirror assembly according to claim 1, wherein said base has an aspect ratio of between 0.025:1 and 0.05:1.

8. A mirror assembly according to claim 1, wherein said supports are in the form of flat spacers.

9. A mirror assembly according to claim 1, wherein said supports have a thickness of less than 1 mm.

10. A mirror assembly according to claim 1, wherein said supports have a width of between 1 and 10 mm.

11. A mirror assembly according to claim 1, wherein each of said mirror blocks is supported on said surface using two supports.

12. A mirror assembly according to claim 1, wherein each of said mirror blocks is supported on said surface using three supports.

13. A mirror assembly according to claim 1, wherein the upper support is substantially flat.

14. A laser interferometer mirror assembly comprising:
a glass base having an upper surface; and
first and second glass mirror blocks;
each of said glass mirror blocks being supported on said upper surface of said glass base using a set of two glass supports, each support being glued to the glass base, each mirror block being glued to a respective set of supports and said first and second glass mirror blocks being arranged on said glass base to provide first and second orthogonal mirrors

15. A laser interferometer mirror assembly comprising:
a glass base having an upper surface; and
first and second glass mirror blocks;
each of said glass mirror blocks being supported on said upper surface of said glass base using a set of three glass supports, each support being glued to the glass base, each mirror block being glued to a respective set of supports and said first and second glass mirror blocks being arranged on said glass base to provide first and second orthogonal mirrors.

16. (canceled)
